(19) United States
(12) Patent Application Publication
(10) Pub. No.: US 2004/0126221 A1
(43) Pub. Date: Jul. 1, 2004

(54) Honeycomb pallet

(76) Inventor: B. Andrew Wolf, St. Louis, MO (US)

Correspondence Address: Anthony G. Fussner, Harness, Dickey & Pierce, P.L.C., Suite 400, 7700 Bonhomme, St. Louis, MO, 63105, US

(21) Appl. No.: 10/331,877

(22) Filed: Dec. 27, 2002

(51) Int. Cl. B66F 1/00

(52) U.S. Cl. 414/814

(57) ABSTRACT

A pallet formed of a honeycomb material. The honeycomb material includes an upper surface on which goods may be placed, a lower surface, a first pair of opposed perimeter walls, and a second pair of opposed perimeter walls. A first pair of slots is integrally formed in the lower surface of the honeycomb material. The first pair of slots extend between the first pair of opposed perimeter walls. A second pair of slots is also integrally formed in the lower surface of the honeycomb material. The second pair of slots extend between the second pair of opposed perimeter walls. Both the first and second pair of slots are engageable by forks of a material handling device.

### FIELD OF THE INVENTION

The present invention relates generally to the handling of goods and more particularly to load carrying pallets.

### BACKGROUND OF THE INVENTION

Pallets, and particularly wooden pallets, have been used for handling goods for many years. Wooden pallets, however, have certain disadvantages. For example, the labor and material costs to produce wooden pallets are relatively high. Therefore, wooden pallets are commonly reused despite the costs associated with storing and/or returning the empty pallets to their owners. In addition, wooden pallets are relatively heavy and thus increase shipping costs, which are usually based upon the weight of the items being shipped. In addition, damaged wooden pallets are usually repaired to avoid the costs associated with obtaining a new wooden pallet and disposing of the damaged wooden pallet. However, there are obviously costs associated with repairing wooden pallets such as downtime and manpower.

More recently, pallets have been constructed from other materials, including paper materials such as cardboard. As recognized by the inventor, however, such pallets are typically constructed using numerous pieces and/or numerous manufacturing steps, thereby increasing the overall cost of such pallets.

### SUMMARY OF THE INVENTION

In order to solve these and other needs in the art, the inventor hereof has succeeded in designing a low cost pallet that can be readily manufactured in an efficient manner and at a low cost. In one embodiment, the pallet of the present invention includes a honeycomb panel having an upper surface, a lower surface, and a plurality of honeycomb cells extending between the upper surface and the lower surface. The honeycomb panel has at least a first pair of slots extending in the lower surface inwardly from a perimeter wall of the honeycomb panel. The first pair of slots are engageable by the forks of a material handling device.

Further areas of applicability of the present invention will become apparent from the detailed description provided hereinafter. It should be understood that the detailed description and specific examples, while indicating at least one exemplary embodiment of the invention, are intended for purposes of illustration only and are not intended to limit the scope of the invention.

### BRIEF DESCRIPTION OF THE DRAWINGS

The present invention will be more fully understood from the detailed description and the accompanying drawings, wherein:

FIG. 1 is an upper perspective view of a honeycomb pallet according to one embodiment of the present invention;

FIG. 2 is a lower perspective view of the honeycomb pallet shown in FIG. 1;

FIG. 3 is a front view of the pallet shown in FIG. 1;

FIG. 4 is a side view of the pallet shown in FIG. 1;

FIG. 5 is a bottom view of the pallet shown in FIG. 1; and

FIG. 6 is a top view of the pallet shown in FIG. 1.

Corresponding reference characters indicate corresponding features throughout the drawings.

### DETAILED DESCRIPTION OF EXEMPLARY EMBODIMENTS

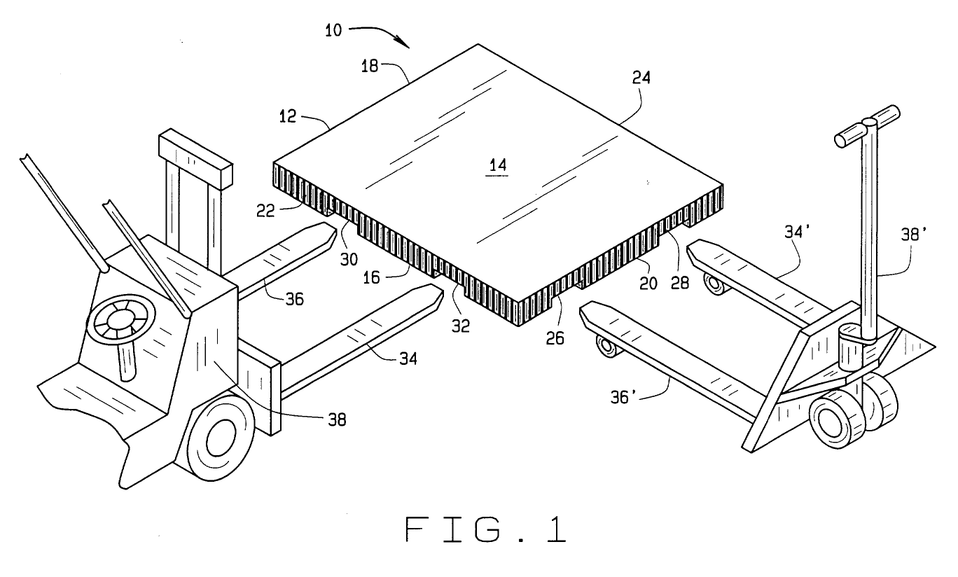

Referring to FIG. 1, there is shown a honeycomb pallet, generally indicated by reference number 10, according to one embodiment of the present invention. As shown in FIG. 1, the pallet 10 of this particular embodiment is formed from a honeycomb panel 12 which itself includes an upper surface 14, a lower surface 16, and a plurality of interconnected honeycomb cells 50 extending between the upper and lower surfaces 14, 16. The honeycomb panel 12 further includes a top sheet of material that defines the upper surface 14, and a lower sheet of material that defines the lower surface 16. It should be understood, however, that the top and bottom sheets of material can be eliminated, in which case the upper and lower surfaces 14, 16 could be defined by the open ends of honeycomb cells extending therebetween. The honeycomb panel 12 further includes a first pair of opposed perimeter walls 18 and 20 and a second pair of opposed perimeter walls 22 and 24. The perimeter wall 22 is best shown in FIG. 3, whereas the perimeter wall 20 is best shown in FIG. 4. As used herein, the term “perimeter wall” shall be construed to include a wall that extends substantially along a perimeter of the upper and/or lower surface 14 and 16 of the pallet 10 even though such wall may be disposed slightly inward or slightly outward from the perimeter.

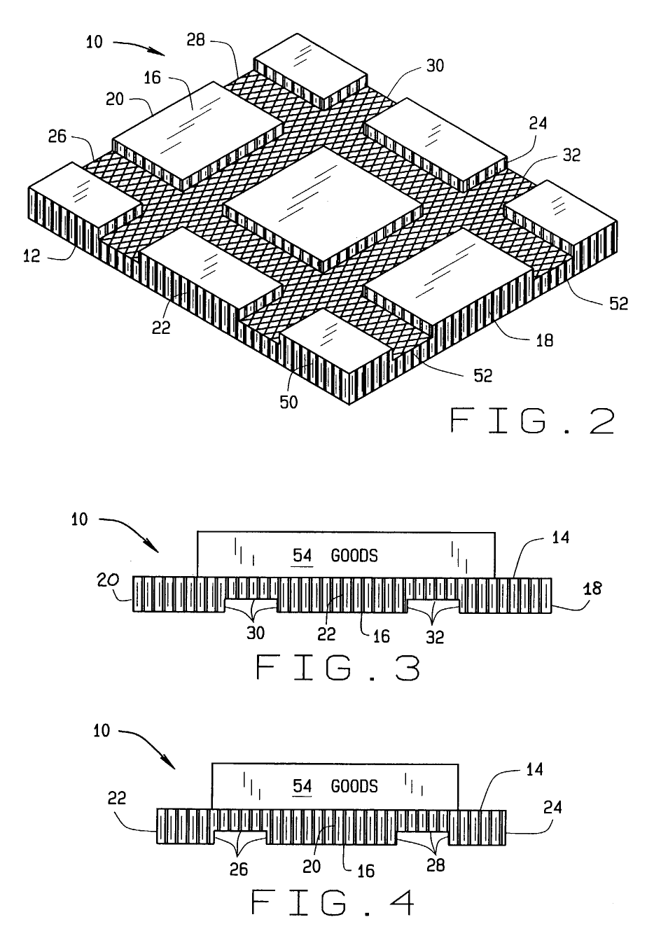

With reference to FIG. 2, the pallet 10 includes a first pair of substantially parallel slots 26 and 28 and a second pair of substantially parallel slots 30 and 32. Each of the slots 26 through 32 are integrally formed in the lower surface 16 in a manner more thoroughly described below. The slots 26 and 28 extend between the perimeter walls 18 and 20, whereas the slots 30 and 32 extends between the perimeter walls 22 and 24. The slots 30 and 32 are substantially perpendicular to the slots 26 and 28.

The first pair of slots 26 and 28 and the second pair of slots 30 and 32 are configured, i.e., sized, shaped, and positioned accordingly, to be engaged by a pair of forks 34 and 36 from a material handling device 38 (FIG. 1). As used herein, the term “material handling device” shall be construed to include any of a wide range of material handling devices including, but not limited to, forklift trucks 38, pallet trucks 38′, hand trucks, hand jacks, hand carts, among other material handling devices.

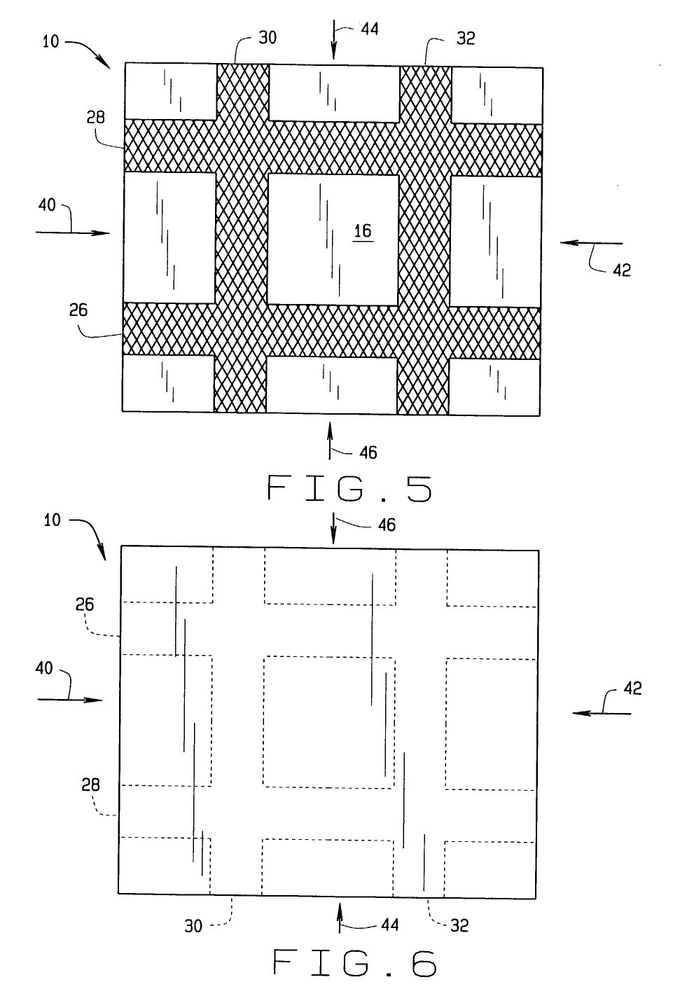

The material handling device 38 can approach the pallet 10 from any one of the four directions 40, 42, 44 and 46 (FIGS. 5 and 6) to engage its forks 34 and 36 with a corresponding pair of the slots 26 through 32. Stated differently, the forks 34 and 36 can be engaged with a corresponding pair of the slots 26 through 32 from any one of the four sides or perimeter walls 18 through 24. Accordingly, the illustrated embodiment of the pallet 10 comprises a four-way entry pallet. In other embodiments, however, the pallet may, for example, comprise a two-way entry pallet.

In the exemplary embodiment shown in FIGS. 3 and 4, each slot 26 through 32 has a cross-section that is substantially u-shaped or c-shaped, the corners of which form right angles. Other cross-sectional shapes are also possible depending on the particular application in which the pallet 10 will be used.

The dimensions and locations of the slots 26 through 32 may vary depending on the requirements of the particular application in which the pallet 10 will be used. Still referring to the exemplary embodiments of FIGS. 3 and 4, each slot 26 through 32 is shown with a depth of about 2.0 inches (5.08 centimeters) and a width of about 8.0 inches (20.32 centimeters). The distance separating the slot 26 from the slot 28 is about 12.0 inches (30.48 centimeters). The distance separate the slot 30 from the slot 32 is about 14.0 inches (35.56 centimeters). In addition, the distance separating the slot 26 from the perimeter wall 22 is about 6.0 inches (15.24 centimeters). The distance separating the slot 28 from the perimeter wall 24 is about 6.0 inches (15.24 centimeters). The distance separating the slot 30 from the perimeter wall 20 is about 10 inches (25.40 centimeters). The distance separating the slot 32 from the perimeter wall 18 is about 10 inches (25.40 centimeters).

Referring to FIGS. 5 and 6, the upper and lower surfaces 14 and 16 of the honeycomb material 12 are shown to be generally rectangular. Although the dimensions of the pallet 10 may vary depending on the application in which the pallet 10 will be used, the pallet 10 in the illustrated embodiment is sized in accordance with an industry standard. More specifically, the upper and lower surfaces 14 and 16 include a length of about 48.0 inches (121.92 centimeters) (FIG. 3) and a width of about 40.0 inches (101.60 centimeters) (FIG. 4). In addition, the pallet 10 has a thickness of about 4.0 inches (10.16 centimeters).

In the exemplary embodiment, the honeycomb pallet 10 is formed of a paper or cardboard material, thus allowing for significant weight reductions, improved cushioning ability, and splinter free handling when compared to wooden pallets. Even though a paper material is used for the pallet 10 in the exemplary embodiment, the cellular honeycomb structure provides the pallet 10 with a remarkable crush strength. For example, and as shown in FIG. 2, each honeycomb cell 50 is substantially diamond-shaped and sized to provide the honeycomb material with a 0.50 inch (1.27 centimeters) cell structure and the capability of withstanding about 40 pounds per square inch. It should be noted, however, that other geometric sizes and shapes (e.g., triangular, rectangular, hexagonal, octagonal, etc.) may be used for the honeycomb cells 50 depending at least in part on the requirements of the particular application in which the pallet 10 will be used. Indeed, a wide variety of honeycomb structures and materials are available, which in turn allows for great diversity in designing the size, shape, and strength of the pallet 10.

In another form, the present invention provides a method of making a pallet. In one embodiment, the method comprises integrally forming the slots 26 through 32 in the lower surface 16 by either removing or displacing a portion of the honeycomb panel 12.

In an exemplary embodiment, the process of die cutting is used to sever portions of the lower liner board 16 and the lower portions of some of the honeycomb cells 50 from the honeycomb panel 12. The severed portions are then removed from the honeycomb panel 12, thereby forming a plurality of truncated honeycomb cells 52 as well as the slots 26 through 32.

In another exemplary method for making a pallet, the process of die cutting is again used. However, instead of being used to sever portions of the honeycomb panel 12, the die cutting is used instead to weaken portions of the lower liner board 16 and the lower portions of some of the honeycomb cells 50. The weakened portions are then displaced or crushed into the honeycomb panel 12, thus forming the slots 26 through 32.

In either method, the slots 26 through 32 are not formed with nails, glues, or other adhesives, which typically are points of weakness for a conventional pallet. Accordingly, integrally forming the slots 26 through 32 enhances the strength of the pallet 10. In addition, the pallet 10 is also readily recyclable and/or biodegradable when formed of paper or cardboard. This, in turn, further reduced costs associated with the manufacture and use of the pallet 10 by at least reducing disposal costs and/or and by conserving landfill space.

Moreover, the slots 26 through 32 are integrally formed in the honeycomb panel 12 after the honeycomb panel 12 has been manufactured. Accordingly, the methods of making the pallet 10 do not require additional steps during the production of the honeycomb panel 12 itself. Thus, the present invention provides a more efficient and cost effective process for making honeycomb pallets than that presently recognized in the art.

In yet another form, the present invention provides a method of handling goods. In one embodiment, the method comprises: providing the honeycomb pallet 10; placing goods 54 on the upper surface 14 of the pallet 10 as shown in FIGS. 3 and 4; and engaging the forks 34 and 36 of the material handling device 38 with either the first pair of slots 26 and 28 or with the second pair of slots 30 and 32 (FIG. 1). Regardless of whether the forks 34 and 36 are engaged with the slots 26 and 28 or with the slots 30 and 32, the forks 34 and 36 contact at least the lower edges of some of the truncated honeycomb cells 52. Once the forks 34 and 36 are engaged with the corresponding slot pair, the forks 34 and 36 may then be raised to lift the pallet 10 and the goods 54. The material handling device 38 may then be used to transport the goods 54 to another location, whereat the forks 34 and 36 may be lowered to place the pallet 10 onto the ground or other support surface. The forks 34 and 36 may then be removed from the corresponding slots.

It should be understood, however, that in the embodiments in which the top sheet of material is eliminated from the pallet, the goods may be placed on the upper open ends of the honeycomb cells. In addition, it should also be understood that the pallet 10 can be used with any of a wide range of material handling devices including, but not limited to, forklift trucks 38, pallet trucks 38′, hand trucks, hand jacks, hand carts, among other material handling devices. Moreover, the slots 26 through 32 allow the material handling device 38 to approach the pallet 10 from any one of the four sides or perimeter walls 18, 20, 22, 24. By providing four-way entry, the present invention allows the material handling device 38 to engage the pallet 10 with less maneuvering of either or both the material handling device 38 and/or the pallet 10.

The description of the invention is merely exemplary in nature and is in no way intended to limit the invention, its application, or uses. Thus, variations that do not depart from the substance of the invention are intended to be within the scope of the invention. Such variations are not to be regarded as a departure from the spirit and scope of the invention.

What is claimed:

1. A method of handling goods, the method comprising:
providing a honeycomb panel having an upper surface, a lower surface, and a plurality of honeycomb cells extending between the upper surface and the lower surface, the honeycomb panel having at least a first pair of slots extending in the lower surface inwardly from a perimeter wall of the honeycomb panel; and
engaging forks of a material handling device with the first pair of slots.

2. The method of claim 1, wherein engaging includes bringing the forks in contact with one or more of the honeycomb cells.

3. The method of claim 1, wherein the honeycomb panel comprises cardboard, and wherein the upper surface and the lower surface each comprise a cardboard sheet.

4. The method of claim 1, wherein the honeycomb panel consists of the upper surface, the lower surface, and the plurality of honeycomb cells.

5. The method of claim 1, further comprising placing goods on and in contact with the upper surface of the honeycomb panel.

6. The method of claim 1, wherein the honeycomb panel has a second pair of slots extending in the lower surface inwardly from a perimeter wall of the honeycomb panel, the method further comprising engaging the forks of the material handling device with the second pair of slots.

7. A pallet comprising a honeycomb panel having an upper surface, a lower surface, and a plurality of honeycomb cells extending between the upper surface and the lower surface, the honeycomb panel having at least a first pair of slots extending in the lower surface inwardly from a perimeter wall of the honeycomb panel, the first pair of slots being engageable by forks of a material handling device.

8. The pallet of claim 7, wherein the honeycomb panel includes a first sheet of material and a second sheet of material, the first sheet of material and the second sheet of material defining the upper surface and the lower surface, respectively.

9. The pallet of claim 8, wherein the first sheet of material and the second sheet of material each comprise cardboard.

10. The pallet of claim 7, wherein the honeycomb panel comprises paper.

11. The pallet of claim 7, wherein each slot is substantially u-shaped in cross section.

12. A method of handling goods, the method comprising:
providing a pallet formed of a honeycomb material, the honeycomb material including an upper surface, a lower surface, a first pair of opposed perimeter walls, and a second pair of opposed perimeter walls, the honeycomb material defining a first pair of slots and a second pair of slots in the lower surface, the first pair of slots extending between the first pair of opposed perimeter walls, the second pair of slots extending between the second pair of opposed perimeter walls; and
engaging forks of a material handling device with one of the first pair of slots and the second pair of slots, the forks contacting one or more cells of the honeycomb material when the forks are engaged with said one of the first pair of slots and the second pair of slots.

13. The method of claim 12, further comprising placing goods on and in contact with the upper surface of the honeycomb material.

14. The method of claim 12, wherein each slot is substantially u-shaped in cross section.

15. A method of making a pallet, the method comprising integrally forming at least a first pair of slots in a lower surface of a honeycomb material, the first pair of slots extending inwardly from a perimeter wall of the honeycomb material and being engageable by forks of a material handling device.

16. The method of claim 15, wherein integrally forming includes removing a portion of the honeycomb material to form the first pair of slots.

17. The method of claim 16, further comprising die cutting said portion prior to the removing.

18. The method of claim 15, wherein integrally forming includes displacing a portion of the honeycomb material to form the first pair of slots.

19. The method of claim 18, further comprising die cutting said portion prior to the displacing.

20. The method of claim 15, wherein the first pair of slots extend between a first pair of opposed perimeter walls of the honeycomb material, and wherein integrally forming includes integrally forming a second pair of slots in the lower surface of the honeycomb material, the second pair of slots extending between a second pair of opposed perimeter walls of the honeycomb material, the second pair of slots being engageable by the forks of the material handling device.

21. The method of claim 15, wherein each slot is substantially u-shaped in cross section.

22. A pallet comprising:
a honeycomb material having a lower surface and at least one perimeter wall; and
at least one pair of slots integrally formed in the lower surface and extending inwardly from the at least one perimeter wall, the at least one pair of slots being engageable by forks of a material handling device.

23. The pallet of claim 22, wherein:
the honeycomb material comprises at least one pair of opposed perimeter walls; and
the at least one pair of slots extends between the at least one pair of opposed perimeter walls.

24. The pallet of claim 23, wherein each slot is substantially u-shaped in cross section.
